(19) United States
(12) Patent Application Publication
(10) Pub. No.: US 2020/0177741 A1
(43) Pub. Date: Jun. 4, 2020

(54) IMAGE FORMING APPARATUS, CONTROL METHOD, AND MACHINE-READABLE NON-TRANSITORY RECORDING MEDIUM STORING INSTRUCTIONS FOR EXECUTING CONTROL METHOD

(71) Applicant: Naoto HAMADA, Kanagawa (JP)

(72) Inventor: Naoto HAMADA, Kanagawa (JP)

(21) Appl. No.: 16/692,081

(22) Filed: Nov. 22, 2019

(30) Foreign Application Priority Data
Nov. 30, 2018 (JP) 2018-225154

(51) Int. Cl. H04N 1/00

(52) U.S. Cl. CPC H04N 1/00214; H04N 1/00954

(57) ABSTRACT

An image forming apparatus, a control method, and a machine-readable non-transitory recording medium storing instructions which, when executed by at least one processor, cause the processor to perform the control method. The image forming apparatus stores a communication history in a first memory for each facsimile communication, compares a number of the communication histories stored in the first memory with a threshold for each facsimile communication, and when the number of communication histories is greater than or equal to the threshold, stores a target communication history among the communication histories stored in the first memory in a second memory and deletes the target communication history stored in the first memory.

### CROSS-REFERENCE TO RELATED APPLICATIONS

This patent application is based on and claims priority pursuant to 35 U.S.C. § 119(a) to Japanese Patent Application No. 2018-225154, filed on Nov. 30, 2018, in the Japan Patent Office, the entire disclosure of which is hereby incorporated by reference herein.

### BACKGROUND

### Technical Field

The present disclosure relates to an image forming apparatus, a control method, and a machine-readable non-transitory recording medium storing instructions which, when executed by at least one processor, cause the processor to perform the control method.

### Background Art

A multifunction peripheral (MFP) having functions such as a printer, a scanner, and a facsimile stores various information (communication history) related to facsimile communication in a nonvolatile memory or the like provided on a board that executes a facsimile function. Such a nonvolatile memory has an upper limit on the number of communication histories that can be stored.

### SUMMARY

Embodiments of the present disclosure describe an image forming apparatus, a control method, and a machine-readable non-transitory recording medium storing instructions which, when executed by at least one processor, cause the processor to perform the control method. The image forming apparatus stores a communication history in a first memory for each facsimile communication, compares a number of the communication histories stored in the first memory with a threshold for each facsimile communication, and when the number of communication histories is greater than or equal to the threshold, stores a target communication history among the communication histories stored in the first memory in a second memory and deletes the target communication history stored in the first memory.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a block diagram illustrating a hardware configuration of an image forming apparatus according to embodiments of the present disclosure;

FIG. 2 is a block diagram illustrating a functional configuration of a facsimile and a control device;

FIG. 3 is a flowchart illustrating a communication process executed by the facsimile;

FIG. 4 is a flowchart illustrating a process executed by the facsimile when a communication history is stored in a save area of a first storage unit;

FIG. 5 is a sequence diagram illustrating a data transfer process between the facsimile and the control device;

FIG. 6 is a flowchart illustrating a communication history generation process executed during facsimile communication;

FIG. 7 is a diagram illustrating an example of the communication history; and

FIG. 8 is a flowchart illustrating a process when registering a new communication history.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Hereinafter, embodiments of the present disclosure is described in detail with reference to drawings. Note that the present disclosure is not limited to these embodiments.

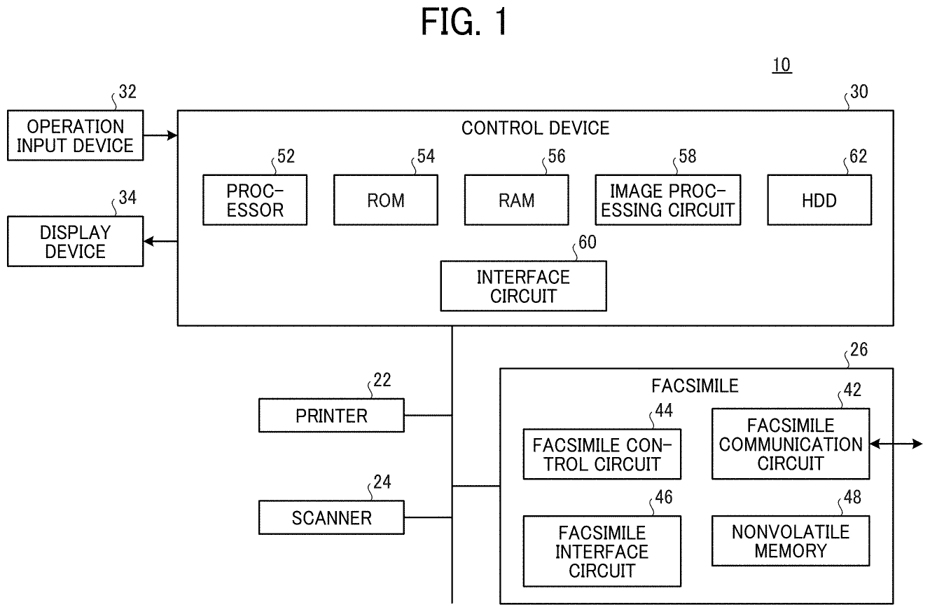

FIG. 1 is a block diagram illustrating a hardware configuration of an image forming apparatus 10 according to embodiments of the present disclosure. The image forming apparatus 10 has at least a facsimile function, for example. In the present embodiment, the image forming apparatus 10 is an MFP having functions of a printer, a scanner, and a facsimile.

The image forming apparatus 10 includes a printer 22, a scanner 24, a facsimile 26, a control device 30, an operation device 32, and a display device 34. The printer 22, the scanner 24, and the facsimile 26 are connected to the control device 30 through a bus.

The printer 22 is a plotter that forms an image for print output. The printer 22 acquires image data and prints an image based on the acquired image data on a sheet. The scanner 24 is a scanner that scans an image into scanned image data. The scanner 24 scans an image printed on the sheet and generates image data.

The facsimile 26 transmits image data to other devices through a telephone line and receives image data from other devices through the telephone line. For example, the facsimile 26 performs facsimile communication with other apparatuses according to an existing standard such as Group (G) 3 or G4. The facsimile 26 is a facsimile control unit (FCU) board.

The facsimile 26 includes a facsimile communication circuit 42, a facsimile control circuit 44, a facsimile interface circuit 46, and a nonvolatile memory 48.

The facsimile communication circuit 42 performs facsimile communication with other devices through the telephone line. The facsimile communication circuit 42 is implemented by a network circuit unit, modem, for example. The facsimile control circuit 44 executes overall control of the facsimile 26. The facsimile control circuit 44 is implemented by a CPU, and/or an ASIC. In one example, the facsimile control circuit 44 executes generation and management of a communication history of facsimile communication. The facsimile interface circuit 46 exchanges information with the control device 30 through the bus. For example, the facsimile interface circuit 46 transfers data to be stored in a memory of the image forming apparatus 10.

The nonvolatile memory 48 is a semiconductor memory that can retain data even when the power is turned off. The nonvolatile memory 48 stores the communication history of facsimile communication under control of the facsimile control circuit 44. The nonvolatile memory 48 is implemented by a SRAM, SDRAM, for example.

The control device 30 executes a program and controls the printer 22, the scanner 24, and the facsimile 26 according to the executed program. The control device 30 is, for example, a control board provided for the image forming apparatus 10. For example, in facsimile transmission, the control device 30 causes the scanner 24 to generate image data corresponding to an image printed on the sheet and provides the generated image data to the facsimile 26. Then, the control device 30 causes the facsimile 26 to transmit the image data to another device. For example, in facsimile reception, the control device 30 acquires image data received by the facsimile 26, transfers the acquired image data to the printer 22, and causes the printer 22 to output an image corresponding to the image data on the sheet.

The control device 30 includes a processor 52, a read only memory (ROM) 54, a random access memory (RAM) 56, an image processing circuit 58, an interface circuit 60, and a hard disk drive (HDD) 62.

The processor 52 is an arithmetic processing circuit such as a central processing unit (CPU). The processor 52 reads a program and data from a storage device such as the ROM 54 or the HDD 62 onto the RAM 56 and executes processing. Thereby, the processor 52 implements the functions of the control device 30.

The ROM 54 is a semiconductor memory that can retain programs and data even when the power is turned off. The ROM 54 stores data such as a program executed when the control device 30 is started up and information to be used for operating system. The RAM 56 is a volatile semiconductor memory that temporarily stores programs and data. The RAM 56 is used as a work area for the processor 52.

The image processing circuit 58 executes compression and decompression of image data to be printed by the printer 22 and image data captured by the scanner 24 or the like. Further, the image processing circuit 58 executes specific image processing in accordance with control by the processor 52. The interface circuit 60 controls data exchange with the printer 22, the scanner 24, and the facsimile 26 through the bus.

The HDD 62 is a magnetic disk storage device that can retain programs and data even when the power is turned off. The HDD 62 stores various programs executed by the processor 52. The HDD 62 stores image data to be printed by the printer 22 and image data captured by the scanner 24.

Further, the HDD 62 stores the communication history of facsimile communication acquired from the facsimile 26 through the bus.

The operation device 32 receives an operation input by a user who operates the image forming apparatus 10 and acquires operation information. The operation input device 32 transfers the acquired operation information to the control device 30. The control device 30 performs control according to the operation information acquired by the operation input device 32. The display device 34 displays information for a user who operates the image forming apparatus 10 according to the control operations executed by the control device 30.

The image forming apparatus 10 may further include a communication device that communicates with an external device through a network. The communication device receives image data to be printed by the printer 22 or image data to be transmitted by the facsimile 26 from another device through the network. In addition, the communication device transmits the image data captured by the scanner 24 or the image data received by the facsimile 26 to another device through the network.

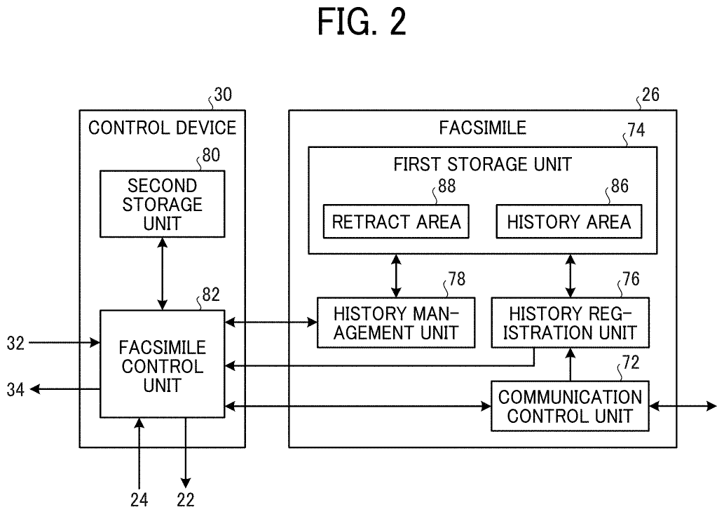

FIG. 2 is a block diagram illustrating a functional configuration of the facsimile 26 and the control device 30.

The facsimile 26 includes a communication control unit 72, a first storage unit 74, a history registration unit 76, and a history management unit 78. The facsimile 26 implements the above-described functional blocks by the software program and hardware operating in cooperation. For example, the facsimile 26 implements the above-described functional blocks by executing a program stored in an internal ROM by a processor or the like. The program may be provided by a storage medium or may be stored in a server or the like and provided through a network.

The control device 30 includes a second storage unit 80 and a facsimile control unit 82. The control device 30 implements the above-described functional blocks by the software program and hardware for controlling the facsimile 26 operating in cooperation. For example, the control device 30 implements the functional blocks by the processor 52 executing a program stored in the ROM 54 or the HDD 62. The program may be provided by a storage medium or may be stored in a server or the like and provided through a network.

The communication control unit 72 controls facsimile communication. The communication control unit 72 is implemented by any one of the facsimile control circuit 44, facsimile communication circuit 42, and facsimile interface circuit 46. For example, in facsimile transmission, as the communication control unit 72, the facsimile interface circuit 46 operating according to instructions from the facsimile control circuit 44, acquires the image data from the facsimile control unit 82 in the control device 30. The facsimile communication circuit 42 operating according to instructions from the facsimile control circuit 44 transmits the acquired image data to an external device according to a certain rule. In another example, in facsimile reception, as the communication control unit 72, the facsimile communication circuit 42 operating according to instructions from the facsimile control circuit 44 acquires image data from the external device according to a certain rule. The facsimile interface circuit 46 operating according to instructions from the facsimile control circuit 44 transfers the acquired image data to the facsimile control unit 82 in the control device 30.

The first storage unit 74 is a nonvolatile storage device implemented by the nonvolatile memory 48. The first storage unit 74 includes a history area 86 that is a storage area allocated in advance and, a retract area 88 that is a storage area allocated in advance. The history area 86 of the first storage unit 74 stores the communication history for each facsimile communication. The retract area 88 of the first storage unit 74 stores the communication history temporarily.

The history registration unit 76 stores the communication history in the history area 86 of the first storage unit 74 for each facsimile communication. The history registration unit 76 is implemented by the facsimile control circuit 44.

The history management unit 78 is implemented by the facsimile control circuit 44. The second storage unit 80 is implemented by a memory, for example, a nonvolatile memory different from the first storage unit 74, such as the HDD 62.

The facsimile control unit 82 is implemented by instructions from the processor 52, or the interface circuit 60 operating according to instructions from the processor 52.

The history management unit 78 compares the number of communication histories stored in the first storage unit 74 with a threshold value for each facsimile communication. The history management unit 78 causes the second storage unit 80 to store the target communication history among the communication histories stored in the first storage unit 74 when the number of communication histories is greater than or equal to the threshold. For example, the facsimile control circuit 44 operating as the history management unit 78 controls the facsimile interface circuit 46 to transmit the target communication history and the write instruction to the facsimile control unit 82. Then, the facsimile control circuit 44 functioning as the history management unit 78 deletes the target communication history stored in the nonvolatile memory 48 functioning as the first storage unit 74.

The target communication history may be a communication history that satisfies a certain condition among the communication histories stored in the first storage unit 74. For example, the target communication history is the oldest communication history among the communication histories stored in the first storage unit 74.

By storing some of the communication histories in the second storage unit 80, the history management unit 78 can still store a large number of communication histories without requiring an increase in the capacity of the first storage unit 74 implemented by the nonvolatile memory 48. Accordingly, the image forming apparatus 10 can store a large number of communication histories at low cost. That is, since the image forming apparatus 10 is usually provided with the HDD 62 on the control device 30, by storing some of communication histories in the HDD 62, a total amount of communication histories that the image forming apparatus 10 can store increase without requiring an increase in the capacity of the nonvolatile memory in the facsimile 26.

When the target communication history is not properly stored in the second storage unit 80, the history management unit 78 stores the target communication history in the retract area 88 in the first storage unit 74. For example, the facsimile control circuit 44 functioning as the history management unit 78 receives a response indicating success or failure of writing from the facsimile control unit 82 via the facsimile interface circuit 46. When the facsimile control circuit 44 functioning as the history management unit 78 receives the response indicating a writing failure from the facsimile control unit 82 via the facsimile interface circuit 46, via the facsimile interface circuit 46 stores the target communication history in the retract area 88 in the first storage unit 74. Thereby, the history management unit 78 can avoid a situation in which the communication history is erased without being written.

After the second storage unit 80 becomes writable, the facsimile control circuit 44 functioning as the history management unit 78 stores in the second storage unit 80, the target communication history stored in the retract area 88 and deletes the target communication history stored in the retract area 88 in the first storage unit 74. For example, when the facsimile control circuit 44 functioning as the history management unit 78 receives information indicating that the second storage unit 80 is writable from the facsimile interface circuit 46 functioning as the facsimile control unit 82, the facsimile control circuit 44 transmits the target communication history and the write instruction to the facsimile interface circuit 46 as the facsimile control unit 82 again and deletes the target communication history stored in the retract area 88. Thereby, the history management unit 78 can securely store the communication history in the second storage unit 80.

The facsimile control circuit 44 as the history management unit 78 outputs a warning indicating that the communication history cannot be written if the writable area of the retract area 88 runs out before the second storage unit 80 becomes writable. For example, when free space in the retract area 88 is reduced to a threshold value or less before the facsimile control circuit 44 as the history management unit 78 receives information indicating that the second storage unit 80 is writable from the facsimile interface circuit 46 functioning as the facsimile control unit 82, the facsimile control circuit 44 transmits the warning to the facsimile interface circuit 46. Thereby, the history management unit 78 can avoid the communication history failing to be stored in any storage.

The second storage unit 80 is a nonvolatile storage device different from the first storage unit 74 and may be implemented by the HDD 62. As described above, the second storage unit 80 stores the communication history that is not stored in the first storage unit 74.

When the operation device 32 accepts a fax transmission operation, the interface circuit 60 operating as the facsimile control unit 82 according to instructions from the processor 52 causes the scanner 24 to scan a sheet and acquire image data. Subsequently, the interface circuit 60 as the facsimile control unit 82 transmits the acquired image data, transmission destination, and transmission instruction to the facsimile interface circuit 46 as the communication control unit 72. When the facsimile interface circuit 46 as the communication control unit 72 receives the transmission instruction from the interface circuit 60 as the facsimile control unit 82, the facsimile communication circuit 42 as the communication control unit 72 transmits the image data to a destination external device by facsimile communication.

Further, the interface circuit 60 as the facsimile control unit 82 acquires image data received by, the facsimile communication circuit 42 as the communication control unit 72 when the communication control unit 72 performs facsimile communication with an external device and receives image data. Then, the interface circuit 60 as the facsimile control unit 82 transfers the acquired image data to the printer 22 to print on a sheet.

When the interface circuit 60 as the facsimile control unit 82 acquires the communication history from the facsimile control circuit 44 as the history management unit 78, the processor 52 functioning as the facsimile control unit 82 stores the acquired communication history in the second storage unit 80. For example, when the interface circuit 60 as the facsimile control unit 82 receives the target communication history and the write instruction from the history management unit 78, the processor 52 as the facsimile control unit 82 writes the target communication history in the second storage unit 80.

When the writing of the target communication history to the second storage unit 80 fails, the interface circuit 60 as the facsimile control unit 82 transmits a write failure response to the facsimile control circuit 44 as the history management unit 78. When the second storage unit 80 becomes writable after transmitting a write failure response, the interface circuit 60 as the facsimile control unit 82 transmits a report indicating that the second storage unit 80 is writable to the facsimile control circuit 44 as the history management unit 78.

When the interface circuit 60 as the facsimile control unit 82 receives an instruction from the facsimile control circuit 44 as the history management unit 78 to output a warning indicating that the communication history cannot be written, the processor 52 as the facsimile control unit 82 displays the warning on the display device 34. In response to receiving the instruction to output the warning indicating that the communication history cannot be written, the processor 52 as the facsimile control unit 82 prohibits subsequent facsimile communication until the warning is canceled.

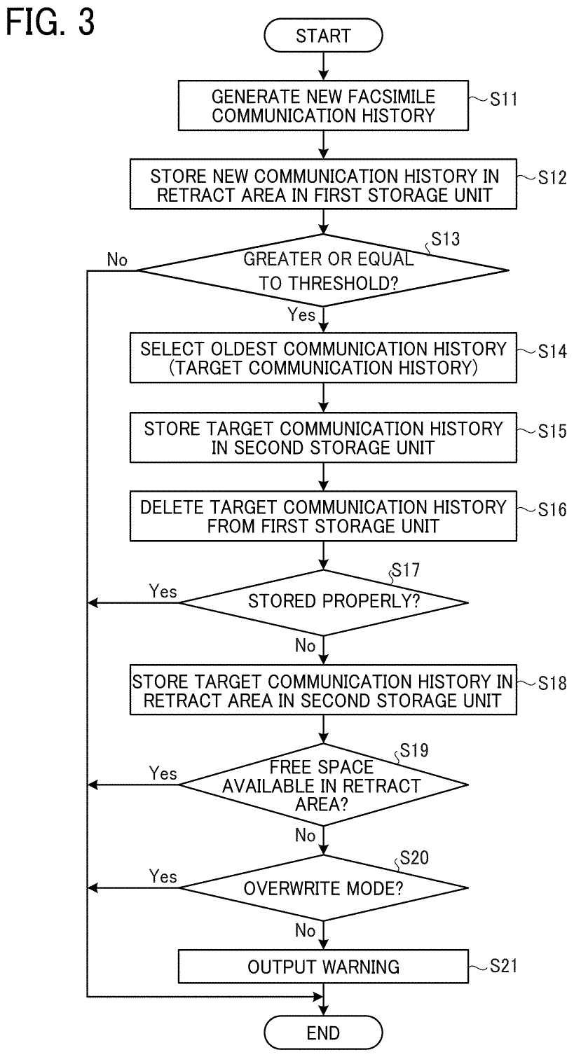

FIG. 3 is a flowchart illustrating a communication process executed by the facsimile 26. When performing facsimile transmission, the facsimile 26 executes processing according to the flowchart illustrated in FIG. 3. In the following the communication control unit 72 and the history registration unit 76 are each implemented by the facsimile control circuit 44.

In step S11, the communication control unit 72 starts facsimile communication. At the same time, the communication control unit 72 generates a new communication history for the facsimile communication.

In step S12, the history registration unit 76 stores the generated new communication history in the nonvolatile memory 48, functioning as the history area 86 of the first storage unit 74, after the facsimile communication is completed.

In step S13, the history management unit 78 compares the number of communication histories stored in the history area 86 of the first storage unit 74 with the threshold. When the number of communication histories is smaller than the threshold (No in step S13), the history management unit 78 ends the process. When the number of communication histories is greater than or equal to the threshold (Yes in step S13), the history management unit 78 advances the process to step S14. The threshold may be previously set, for example, according to capacity of the nonvolatile memory 48.

In step S14, the history management unit 78 selects a target communication history that satisfies a certain condition from among a plurality of communication histories stored in the history area 86 of the first storage unit 74. In the present embodiment, the history management unit 78 selects the oldest communication history as the target communication history. The history management unit 78 may select a plurality of communication histories as the target communication history, for example, in order from the oldest. The certain condition for selecting a target communication history may be previously set according to a system administrator or user preference and stored in a memory.

In step S15, the history management unit 78 stores the target communication history in the HDD 62 as the second storage unit 80. For example, the history management unit 78 transmits the target communication history and the write instruction to the interface circuit 60 as the facsimile control unit 82. In step S16, the history management unit 78 deletes the target communication history stored in the history area 86 of the first storage unit 74.

In step S17, the history management unit 78 determines whether the target communication history is properly stored in the second storage unit 80. For example, the history management unit 78 transmits the target communication history and the write instruction to the facsimile control unit 82 and temporarily stores the target communication history in a buffer. Then, the history management unit 78 determines whether the target communication history is properly stored in the second storage unit 80 based on a response indicating a writing success or a writing failure transmitted from the facsimile control unit 82.

When the target communication history is properly stored in the second storage unit 80 (Yes in step S17), the history management unit 78 deletes the target communication history temporarily stored in the buffer and ends this process. When the target communication history is not properly stored in the second storage unit 80 (No in step S17), the history management unit 78 advances the process to step S18.

In step S18, the history management unit 78 stores the target communication history temporarily held in the buffer in the retract area 88 of the first storage unit 74. Then, the history management unit 78 deletes the target communication history temporarily stored in the buffer.

In step S19, the history management unit 78 determines whether or not there is free space equal to or greater than a threshold value in the retract area 88 of the first storage unit 74. When there is free space greater than or equal to the threshold value in the retract area 88 of the first storage unit 74 (Yes in step S19), the history management unit 78 ends this process. When free space greater than or equal to the threshold value is not available in the retract area 88 of the first storage unit 74 (No in step S19), the history management unit 78 advances the process to step S20.

In step S20, the history management unit 78 determines whether an overwrite mode is set for writing to the retract area 88. The overwrite mode enables new history information to be overwritten on stored history information when sufficient free space is not available in the retract area 88. When the overwrite mode is set (Yes in step S20), the history management unit 78 ends this process. When the overwrite mode is not set (No in step S20), the history management unit 78 advances the process to step S21. The overwrite mode may be set by a system administrator or according to the user preference, for example.

In step S21, the history management unit 78 outputs the warning indicating that the communication history cannot be written. For example, the history management unit 78 transmits to the interface circuit 60 as the facsimile control unit 82 the instruction to output the warning indicating that the communication history cannot be written. When the facsimile control unit 82 receives the instruction to output the warning indicating that the communication history cannot be written from the history management unit 78, the processor 52 as the facsimile control unit 82 displays the warning on the display device 34. At the same time, the facsimile control unit 82 prohibits subsequent facsimile communication until the warning is canceled.

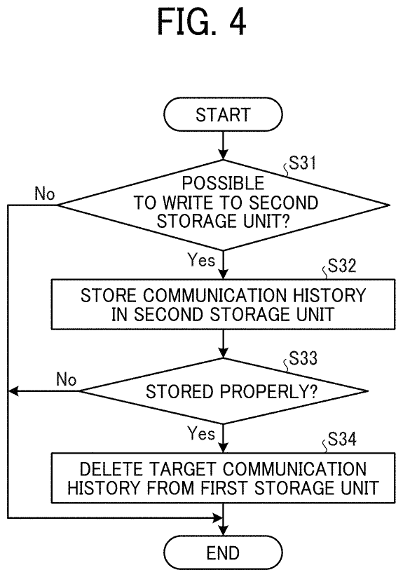

FIG. 4 is a flowchart illustrating a process executed by the facsimile 26 when the communication history is stored in the retract area 88 of the first storage unit 74. When the communication history is stored in the retract area 88 of the first storage unit 74, the facsimile 26 executes the process according to the flowchart illustrated in FIG. 4.

In step S31, the history management unit 78 determines whether the second storage unit 80 is writable. For example, the history management unit 78 may receive an interrupt notice indicating that the second storage unit 80 is writable from the facsimile control unit 82, and in response, the history management unit 78 may determine that the second storage unit 80 is writable. Alternatively, the history management unit 78 may periodically query the facsimile control unit 82 to determine whether or not the second storage unit 80 is writable.

When the second storage unit 80 is not writable (No in step S31), the history management unit 78 ends this process. When the second storage unit 80 is writable (Yes in step S31), the history management unit 78 advances the process to step S32.

In step S32, the history management unit 78 stores the communication history stored in the retract area 88 of the first storage unit 74, in the second storage unit 80. For example, the history management unit 78 transmits the communication history stored in the retract area 88 and the write instruction to the facsimile control unit 82.

In step S33, the history management unit 78 determines whether the communication history is properly stored in the second storage unit 80. When the communication history is not properly stored in the second storage unit 80 (No in step S33), the history management unit 78 ends this process. When the communication history is properly stored in the second storage unit 80 (Yes in step S33), the history management unit 78 advances the process to step S34.

In step S34, the history management unit 78 deletes the communication history stored in the retract area 88 of the first storage unit 74. Furthermore, when the warning indicating that the communication history cannot be written is output, the history management unit 78 transmits an instruction to cancel the warning to the facsimile control unit 82. After completing step S34, the history management unit 78 ends the process.

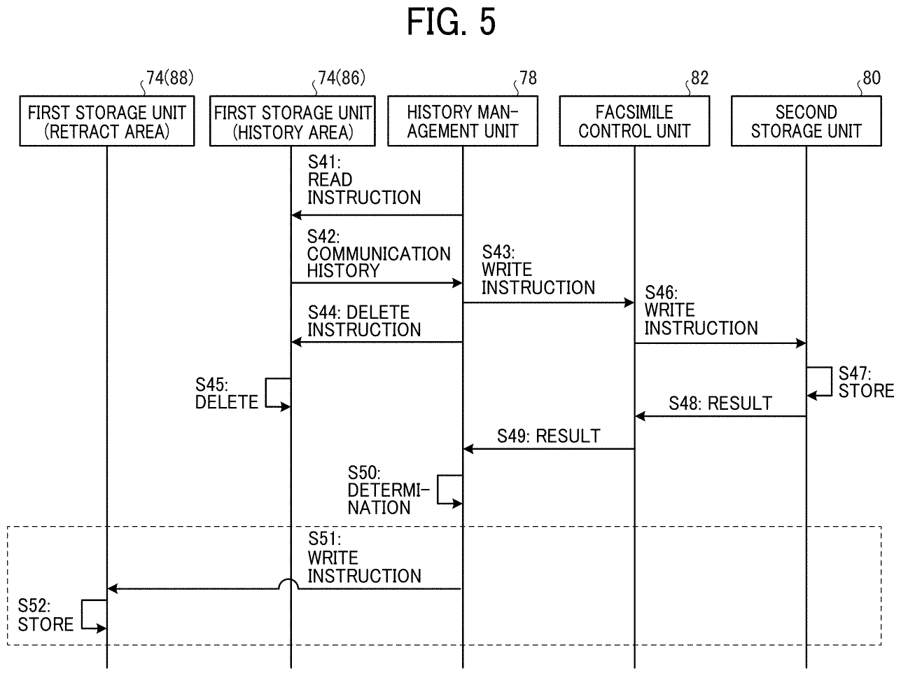

FIG. 5 is a sequence diagram illustrating a data transfer process between the facsimile 26 and the control device 30. When the facsimile 26 selects a target communication history to be stored in the second storage unit 80 from among a plurality of communication histories stored in the history area 86 of the first storage unit 74, the facsimile 26 and the control device 30 execute the process illustrated in FIG. 5. As described above, the history management unit 78 is implemented by the facsimile control circuit 44, which may operate in cooperation with the facsimile interface circuit 46. The first storage unit 74 is implemented by the nonvolatile memory 48. The facsimile control unit 82 is implemented by the processor 52, which may operate in cooperation with the interface circuit 60. The second storage unit 80 is implemented by the HDD 62.

In step S41, the history management unit 78 transmits a read instruction to read the target communication history to the first storage unit 74. In step S42, the first storage unit 74 transfers the target communication history read out from the history area 86 to the history management unit 78.

In step S43, the history management unit 78 transmits a write instruction to the facsimile control unit 82. In step S44, the history management unit 78 transmits a delete instruction to the first storage unit 74. In step S45, the first storage unit 74 deletes the target communication history read out from the history area 86 at S41.

In step S46, the facsimile control unit 82 transmits the write instruction to the second storage unit 80. The write instruction may include the target communication history to be stored. In step S47, the second storage unit 80 stores the target communication history. In step S48, the second storage unit 80 transmits a result indicating whether storage of the target communication history has succeeded or failed to the facsimile control unit 82.

In step S49, the facsimile control unit 82 transmits the result indicating whether the storage of the target communication history has succeeded or failed to the history management unit 78. In step S50, the history management unit 78 determines whether the storage of the target communication history by the second storage unit 80 has succeeded or failed. When successful, the history management unit 78 ends the process.

When the history management unit 78 determines that the storage of the target communication history by the second storage unit 80 has failed, the history management unit 78 transmits the write instruction to the first storage unit 74 in step S51. The write instruction may include the target communication history to be stored. In step S52, the first storage unit 74 stores the target communication history in the retract area 88.

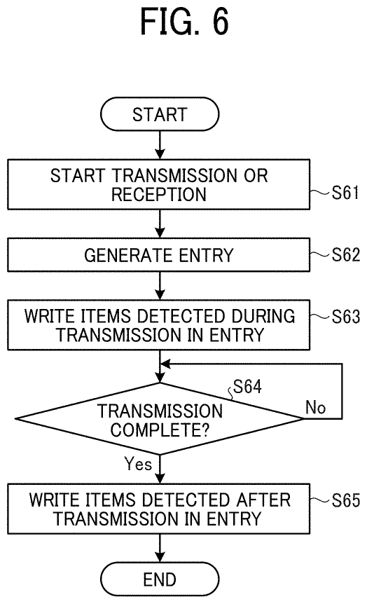

FIG. 6 is a flowchart illustrating a communication history generation process executed during facsimile communication. The facsimile 26 generates a communication history in the process illustrated in FIG. 6 during facsimile communication. The communication control unit 72 is implemented by the facsimile control circuit 44.

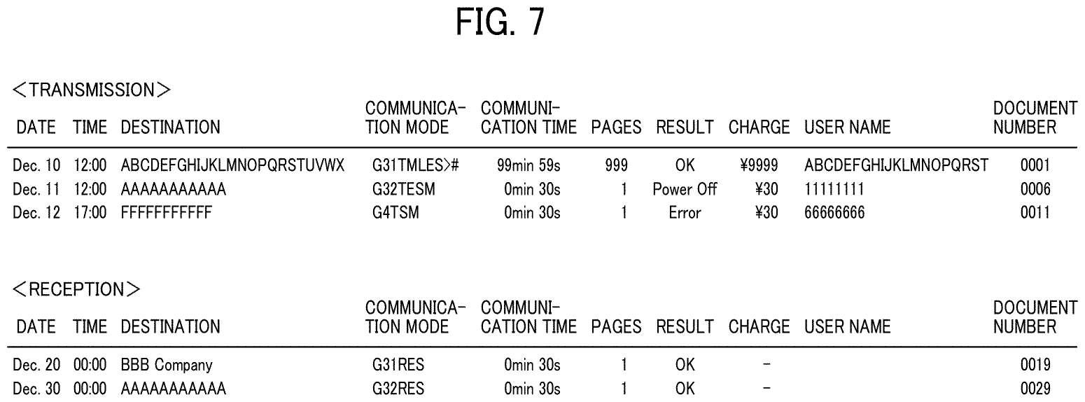

In step S61, the communication control unit 72 starts transmission or reception of facsimile communication via the facsimile communication circuit 42. In step S62, the communication control unit 72 generates an entry for temporarily storing the communication history in the buffer. In step S63, the communication control unit 72 writes an item that can be detected during facsimile communication in the entry. Examples of such item to be detected are described below referring to FIG. 7. In step S64, the communication control unit 72 determines whether the transmission or reception of facsimile communication has been completed. If the communication is not completed (No in step S64), the communication control unit 72 waits for the process to end, by repeating step S64. If the communication is completed (Yes in step S64), the communication control unit 72 advances the process to step S65. In step S65, the communication control unit 72 writes an item that can be detected after facsimile communication in the entry.

After step S65 is completed, the history registration unit 76 writes information of each item stored in the entry in the history area 86 of the first storage unit 74.

FIG. 7 is a diagram illustrating an example of a communication history. For example, the first storage unit 74 stores items as illustrated in FIG. 7 as the communication history.

For example, the communication history includes date, time, destination, communication mode, communication time, number of sheets, result, charge, user name, and document number. The communication history for the facsimile reception may not include the charge and the user name.

The destination is a telephone number indicating the destination of facsimile communication or information registered in association with the telephone number. The communication mode is various settings information necessary for facsimile communication. The result is information indicating whether or not the facsimile communication is successful. The user name is information registered in the facsimile 26 in advance as a destination of facsimile communication.

Note that the communication history may further include other information in addition to the information described above.

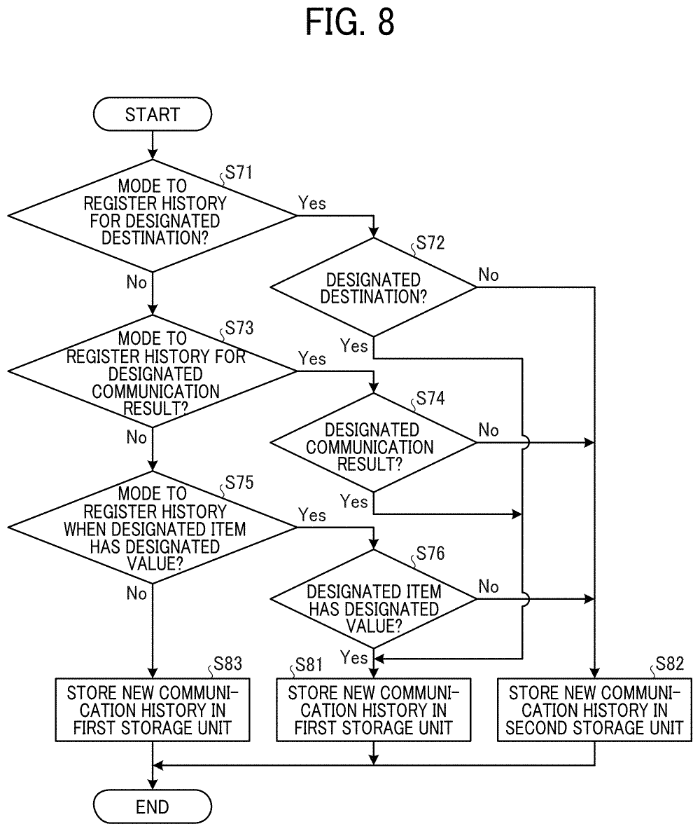

FIG. 8 is a flowchart illustrating a registration process of registering a new communication history. When the new communication history is to be registered after the facsimile communication is completed, the history registration unit 76, which may be implemented by the facsimile control circuit 44, may perform the registration process as illustrated in FIG. 8.

In step S71, the history registration unit 76 determines whether a mode for registering a communication history with a designated destination is set. When the mode for registering the communication history with the designated destination is set (Yes in step S71), the history registration unit 76 advances the process to step S72. In step S72, the history registration unit 76 determines whether communication with the designated destination is performed.

When the communication is with the designated destination (Yes in step S72), the history registration unit 76 advances the process to step S81. In step S81, the history registration unit 76 stores the new communication history in the history area 86 of the first storage unit 74. When the communication is not with the designated destination (No in step S72), the history registration unit 76 advances the process to step S82. In step S82, the history registration unit 76 stores the new communication history in the second storage unit 80. Thereby, by using the second storage unit 80, the image forming apparatus 10 can increase the number of communication histories with the designated destination that can be stored without requiring an increase in the capacity of the first storage unit 74.

When the mode for registering the communication history with the designated destination (No in step S71) is not set, the history registration unit 76 advances the process to step S73.

In step S73, the history registration unit 76 determines whether a mode for registering a communication history depending on communication result is set. For example, the history registration unit 76 determines whether a mode to register a failed facsimile communication is set. When the mode for registering the communication history depending on the communication result is set (Yes in step S73), the history registration unit 76 advances the process to S74. In step S74, the history registration unit 76 determines whether the communication result is a designated communication result. For example, the history registration unit 76 determines whether the facsimile communication has failed.

When the communication result is the designated result (Yes in step S74), for example, if the facsimile communication has failed, the history registration unit 76 advances the process to step S81. In step S81, the history registration unit 76 stores the new communication history in the history area 86 of the first storage unit 74. If the communication result is not the designated result (No in step S74), for example, if the facsimile communication is successful, the history registration unit 76 advances the process to step S82. In step S82, the history registration unit 76 stores the new communication history in the second storage unit 80. Thereby, using the second storage unit 80, the image forming apparatus 10 can increase the number of communication histories of the designated communication result (for example, communication histories when facsimile communication fails) that can be stored without requiring an increase in the capacity of the first storage unit 74.

If the mode for registering the communication history of the designated communication result (No in step S73) is not set, the history registration unit 76 advances the process to step S75.

In step S75, the history registration unit 76 determines whether a mode for registering a communication history in which a designated item in the communication history has a designated value is set. For example, the history registration unit 76 determines whether a mode to register communication history when the charge is equal to or higher than a designated value is set. When the mode for registering a communication history when the designated item in the communication history has the designated value is set (Yes in step S75), the history registration unit 76 advances the process to step S76. In step S76, the history registration unit 76 determines whether the designated item in the communication history has the designated value. For example, the history registration unit 76 determines whether the charge is equal to or higher than the designated value.

When the designated item in the communication history has the designated value (Yes in step S76), for example, when the charge is equal to or higher than the designated value, the history registration unit 76 advances the process to S81. In step S81, the history registration unit 76 stores the new communication history in the history area 86 of the first storage unit 74. When the designated item in the communication history is not the designated value (No in step S76), for example, if the charge is not equal to or lower than the designated value, the history registration unit 76 advances the process to step S82. In step S82, the history registration unit 76 stores the new communication history in the second storage unit 80. Thereby, using the second storage unit 80, the image forming apparatus 10 can increase the number of communication histories in which the designated item is the designated value (for example, communication history whose charge is equal to the designated value or more) that can be stored without requiring an increase in the capacity of the first storage unit 74.

In addition, when the mode for registering the communication history in which the designated item in the communication history is the designated value is not set (No in step S75), the history registration unit 76 advances the process to step S83 assuming that no mode is set. In step S83, the history registration unit 76 stores the corresponding communication history in the history area 86 of the first storage unit 74.

When step S81, S82, or S83 is completed, the history registration unit 76 ends this process.

As described above, the image forming apparatus 10 according to the present embodiment stores the target communication history in the second storage unit 80 different from the first storage unit 74, when the number of communication histories stored in the first storage unit 74 implemented by the semiconductor nonvolatile memory 48 is greater than or equal to the threshold value. Thus, according to the image forming apparatus 10 of the present embodiment, a large number of facsimile communication histories can be stored without requiring an increase in the capacity of the first storage unit 74 which is, for example, the semiconductor nonvolatile memory 48. Accordingly, the image forming apparatus 10 can store a large number of communication histories at low cost.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming apparatus, comprising:
a first memory implemented by a nonvolatile memory;
a second memory implemented by a nonvolatile memory different from the first memory; and
circuitry configured to:
store a communication history in the first memory for each facsimile communication;
compare a number of the communication histories stored in the first memory with a threshold for each facsimile communication; and
when, the number of communication histories is greater than or equal to the threshold:
store a target communication history among the communication histories stored in the first memory in the second memory; and
delete the target communication history stored in the first memory.

2. The image forming apparatus of claim 1, wherein
the target communication history is the oldest communication history among the communication histories stored in the first memory.

3. The image forming apparatus of claim 1, wherein
when the target communication history is not properly stored in the second memory the circuitry is further configured to:
store the target communication history in a retract area reserved in the first memory;
store the target communication history stored in the retract area in the second memory after the second memory becomes writable; and
delete the target communication history stored in the retract area in the first memory.

4. The image forming apparatus of claim 3, wherein the circuitry is further configured to output a warning when there is no writable area in the retract area before the second memory becomes writable.

5. The image forming apparatus of claim 1, wherein the circuitry is further configured to:
determine whether the facsimile communication is with a designated destination for each facsimile communication;
store a corresponding communication history in the first memory when the facsimile communication is with the designated destination; and
store the corresponding communication history in the second memory when the facsimile communication is with a destination different from the designated destination.

6. The image forming apparatus of claim 1, wherein the circuitry is further configured to:
determine whether a designated communication result is obtained for each facsimile communication;
store a corresponding communication history in the first memory when the communication result is the designated communication result; and
store the corresponding communication history in the second memory when the communication result is different from the designated communication result.

7. The image forming apparatus of claim 1, wherein the circuitry is further configured to:
determine whether a designated item included in the communication history has a designated value for each facsimile communication;
store a corresponding communication history in the first memory, when the designated item included in the communication history has the designated value; and
store the corresponding communication history in the second memory, when the designated item included in the communication history has a value different from the designated value.

8. A control method comprising:
storing a communication history in a first memory implemented by a nonvolatile memory for each facsimile communication;
comparing a number of the communication histories stored in the first memory with a threshold for each facsimile communication; and
when the number of communication histories is greater than or equal to the threshold:
storing a target communication history among the communication histories stored in the first memory in a second memory implemented by a nonvolatile memory different from the first memory; and
deleting the target communication history stored in the first memory.

9. The control method of claim 8, wherein
the target communication history is the oldest communication history among the communication histories stored in the first memory.

10. The control method of claim 8, wherein when the target communication history is not properly stored in the second memory, the control method further comprises:
storing the target communication history in a retract area reserved in the first memory;
storing the target communication history stored in the retract area in the second memory after the second memory becomes writable; and
deleting the target communication history stored in the retract area in the first memory.

11. The control method of claim 10, further comprising outputting a warning when there is no writable area in the retract area before the second memory becomes writable.

12. The control method of claim 8, further comprising:
determining whether the facsimile communication is with a designated destination for each facsimile communication;
storing a corresponding communication history in the first memory when the facsimile communication is with the designated destination; and
storing the corresponding communication history in the second memory when the facsimile communication is with a destination different from the designated destination.

13. The control method of claim 8, further comprising:
determining whether a designated communication result is obtained for each facsimile communication;
storing a corresponding communication history in the first memory when the communication result is the designated communication result; and
storing the corresponding communication history in the second memory when the communication result is different from the designated communication result.

14. The control method of claim 8, further comprising:
determining whether a designated item included in the communication history has a designated value for each facsimile communication;
storing a corresponding communication history in the first memory, when the designated item included in the communication history has the designated value; and
storing the corresponding communication history in the second memory, when the designated item included in the communication history has a value different from the designated value.

15. A machine-readable, non-transitory recording medium storing a plurality of instructions which, when executed by at least one processors, cause the processors to perform a control method comprising:
storing a communication history in a first memory implemented by a nonvolatile memory for each facsimile communication;
comparing number of the communication histories stored in the first memory with a threshold for each facsimile communication; and
when the number of communication histories stored in the first memory is greater than or equal to the threshold;
storing a target communication history among the communication histories stored in the first memory in a second memory implemented by a nonvolatile memory different from the first memory; and
deleting the target communication history stored in the first memory.

16. The machine-readable, non-transitory recording medium of claim 15, wherein
the target communication history is the oldest communication history among the communication histories stored in the first memory.

17. The machine-readable, non-transitory recording medium of claim 15, wherein when the target communication history is not properly stored in the second memory, the control method further comprises:
storing the target communication history in a retract area reserved in the first memory;
storing the target communication history stored in the retract area in the second memory after the second memory becomes writable; and
deleting the target communication history stored in the retract area in the first memory.

18. The machine-readable, non-transitory recording medium of claim 15, wherein the control method further comprises:
determining whether the facsimile communication is with a designated destination for each facsimile communication;
storing a corresponding communication history in the first memory when the facsimile communication is with the designated destination; and
storing the corresponding communication history in the second memory when the facsimile communication is with a destination different from the designated destination.

19. The machine-readable, non-transitory recording medium of claim 15, wherein the control method further comprises:
determining whether a designated communication result is obtained for each facsimile communication;
storing a corresponding communication history in the first memory when the communication result is the designated communication result; and
storing the corresponding communication history in the second memory when the communication result is different from the designated communication result.

20. The machine-readable, non-transitory recording medium of claim 15, wherein the control method further comprises:
determining whether a designated item included in the communication history has a designated value for each facsimile communication;
storing a corresponding communication history in the first memory, when the designated item included in the communication history has the designated value; and
storing the corresponding communication history in the second memory, when the designated item included in the communication history has a value different from the designated value.
